(19) United States
(12) Patent Application Publication
(10) Pub. No.: US 2013/0001366 A1
(43) Pub. Date: Jan. 3, 2013

(54) LANDING SYSTEM

(75) Inventors: Amit Wolff, Zur Moshe (IL); Lior Zivan, Hadera (IL); Guy Dekel, Katzir (IL); Avraham Baum, Ra'anana (IL)

(73) Assignee: ISRAEL AEROSPACE INDUSTRIES LTD., Lod (IL)

(21) Appl. No.: 13/583,765

(22) PCT Filed: Mar. 10, 2011
(86) PCT No.: PCT/IL11/00236

§ 371 Date: Sep. 10, 2012

(30) Foreign Application Priority Data
Mar. 15, 2010 (IL) 204509

(51) Int. Cl. B64F 1/00; B64C 13/16

(52) U.S. Cl. 244/183

(57) ABSTRACT

A system for landing a VTOL aircraft on a landing platform, comprises a) a net, positioned in a plane substantially parallel to the plane of the landing platform; b) proximity sensors suitable to provide data indicative of the distance and orientation of the aircraft from said net; c) sensors suitable to gauge environmental conditions relevant to the landing of the aircraft; and d) control apparatus to control the speed at which the aircraft approaches said net.

### FIELD OF THE INVENTION

The present invention relates to the landing of aircrafts provided with vertical takeoff and landing capability. More particularly, the invention relates to the landing of such aircrafts on moving landing platforms.

### BACKGROUND OF THE INVENTION

Manned and unmanned VTOL (vertical takeoff and landing) aircrafts have become increasingly important in latest years, to perform both military and civil operations for which actual runways are not available. One particularly important application of VTOL aircrafts is their ability to land on the deck of a ship and to be relaunched from it. Of course, ships are not the sole target for such aircrafts and the above ability, as well as the invention to be described hereinafter, are relevant and important in many other cases in which relative motion takes place between the aircraft and the landing platform, as may be the case for instance with a moving vehicle on land.

As will be appreciated by a skilled person, when approaching a moving platform for landing it is important to be able to estimate the status of the platform at any given time, so as to direct the landing vehicle to approach it correctly. More so, when the landing platform also rolls with sharp angles as may be the case with a ship in bad weather. Various methods have been devised in the art to deal with this issue, which are well known to the skilled person and therefore will not be discussed herein in detail, for the sake of brevity. One such approach was developed by Bernie Ferrier, and is know as the landing period designator (LPD). The LPD is primarily a visual aid that provides air and ground crew an unambiguous means of interpreting helicopter and ship safe landing and deck handling conditions (see, for instance, Naval Engineers Journal, ISSN 0028-1425: “ASNE Day 2000, Arlington, Va., USA, 2000, vol. 112, no. 4 (397 p.) (17 ref.), pp. 297-315), that discusses the method. LPD was developed to describe in real-time the responses of an air vehicle to the boundary layer processes during air vehicle launch and recovery. It is an attempt to pay greater attention to the dynamic issues encountered by free bodies (air vehicles, for example) on launch and recovery.

Solutions provided in the art to the problem of landing aircrafts on moving platforms, which have concentrated on landing on ships, are all complicated, expensive and impractical and, moreover, they entail the grave danger of causing mechanical damage to the landing aircraft. Such solutions revolve around a net that is lifted vertically on the ship deck, into which net the aircraft crashes and thereafter is caught in the mesh from which it is lowered onto the deck using specialized apparatus. Another approach uses a robot arm with a capture mechanism that captures the aircraft wing and causes the aircraft to rotate around the axis of the arm until it comes to a halt. In most cases mechanical damage is experienced with both arrangements, requiring substantial repair of the aircraft. In addition to the cost of such repairs, the upshot is that the aircraft cannot be quickly used again to take off from the ship for the next mission.

It is an object of the present invention to provide a method and system that obviate the aforementioned drawbacks of the prior art.

It is another object of the invention to provide a method and system that permit to land a VTOL aircraft on a moving platform with minimal damage, applying a relatively simple system.

It is a further object of the invention to provide a landing system and method that can be operated easily, either automatically or by an operator, in conjunction with a variety of moving platforms.

Other objects and advantages of the invention will become apparent as the description proceeds.

### SUMMARY OF THE INVENTION

In one aspect the invention relates to a system for landing a VTOL aircraft on a landing platform, comprising:
a) a net, positioned in a plane substantially parallel to the plane of the landing platform;
b) proximity sensors suitable to provide data indicative of the distance and orientation of the aircraft from said net;
c) sensors suitable to gauge environmental conditions relevant to the landing of the aircraft; and
d) control apparatus to control the speed at which the aircraft approaches said net.

The net can be positioned above a solid surface or above or beside a moving surface. In one embodiment of the invention the landing platform is a ship and the net is positioned outside its deck.

The proximity sensors can be located on the aircraft or on the landing platform, or in both locations. Obtaining data from proximity sensors is a well known task to skilled persons and, therefore, it is not discussed in detail herein, for the sake of brevity. The sensors suitable to gauge environmental conditions include one or more of roll angle sensors, wind speed sensors, ship speed sensors, relative positioning of the landing surface and the aircraft and the rate of change of the relative heights of the aircraft and the landing surface.

In another aspect the invention is directed to a method for landing a VTOL aircraft on a landing platform, comprising the steps of:
a) positioning a net in a plane substantially parallel to the plane of the landing platform;
b) reading proximity data provided by proximity sensors gauging the distance and orientation of the aircraft from said net;
c) gauging environmental conditions relevant to the landing of the aircraft; and
d) controlling the speed at which the aircraft approaches said net according to said proximity data and environmental conditions, until its fuselage rests in said net.

Controlling of the landing can be carried out by a human operator or by an automated system, or by a combination of both. The automated system may be provided with a variety of sensors and modules and comprises, for instance, one or more of GPS, optical locking means, proximity sensors and circuitry for transforming sensed data into input readable by the flight control system.

### BRIEF DESCRIPTION OF THE DRAWINGS

In the drawings:

FIG. 1 (A-B) schematically illustrates the approaching stages of the aircraft;

FIG. 2 shows the aircraft once it has landed, according to one embodiment of the invention; and

FIG. 3 illustrates an arrangement according to an alternative embodiment of the invention.

### DETAILED DESCRIPTION OF THE INVENTION

The method and system of the invention, as summarized above, is strikingly simpler to put in place and operate than the prior art with its complex systems and the drawbacks detailed above. For instance, US2004256519A requires the addition of shoes affixed to a lower portion of the aircraft such as to interlock with a retaining medium on a landing pad. US2009294584A employs a complex robot arm and requires the mounting of a hook on the fuselage of the aircraft. US2009224097A employs a complex slingshots structure with pulling and breaking means that cause the aircraft to rotate on the deck. In comparison, as will be easily understood by the skilled person from the description to follow, the invention overcomes all the disadvantages of such complex systems, while providing an easy-to-operate solution.

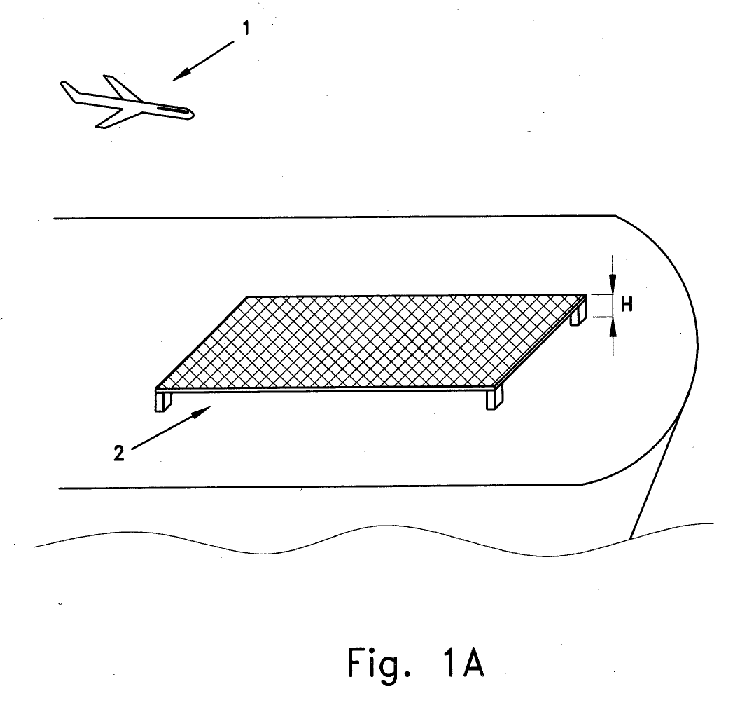

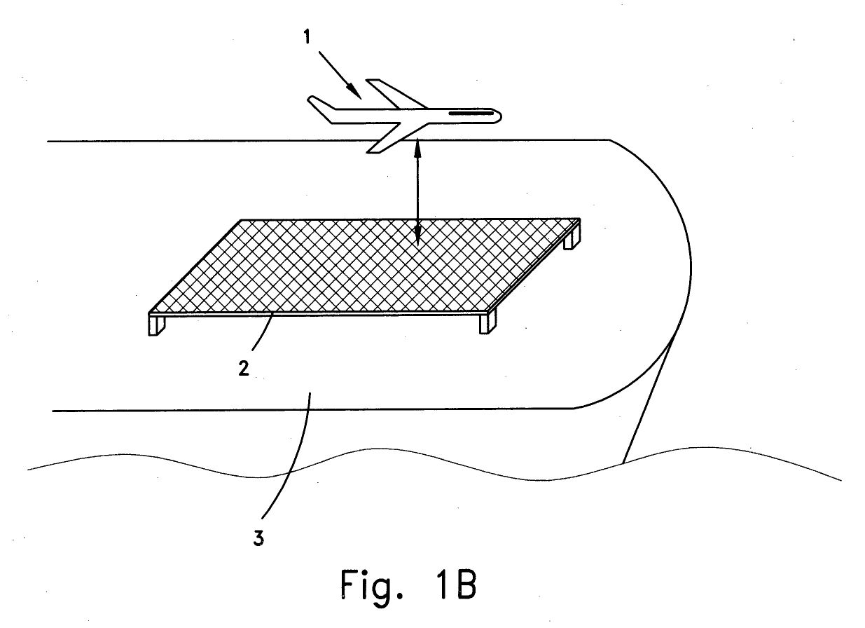

FIG. 1A shows the initial stages of the approach of the VTOL aircraft 1. For the purpose of illustration reference is made to the deck of a ship although, as stated hereinbefore, the invention is not limited to any particular landing platform and is useful in all cases in which relative motion exists, i.e., when the landing platform is not a stationary platform. Moreover, the invention is not limited to a situation in which substantial motion of the platform exists, although as said it is particularly advantageous in such situations, but it is also useful when the landing platform is fully stationary, as may be the case, for instance on a large ship in a calm sea, where the relative motion is minimal.

A substantially horizontal net 2 is spread on deck 3. The size of the net must be such that it is larger than needed to accommodate the fuselage of the aircraft and, of course, may vary in size depending on the type of aircraft that it is intended to use. Likewise, the height “H” at which the net will be positioned above the deck level is a function of the weight of the aircraft and may vary from one model to another. The net can fulfill two functions: a) if it is spread above and close to a solid surface it can be positioned as close as 2 centimeters above it since its main function in this case is to prevent the aircraft from sliding along the solid surface, and to entrap it at the landing location. B) If, on the other hand, the net is spread at a greater height above a solid surface, or where no solid surface exists, such as on the side of a ship and above water, it functions fully as the landing surface and the aircraft rests in it without touching any solid surface.

The size of the net is, of course, dependent on the size of the aircraft. An indicative (but non-limitative) size criterion is that the width be twice the full open length of its wings, and the length be the same as the width, to give a square net area. Of course, alternative sizes can be used, depending on specific requirements and desired sizes can easily be devised by the skilled person.

The net can be made of any suitable material and in one embodiment it is made of an energy-absorbing material, such as elastic polymeric material.

In FIG. 1B the aircraft has reached its pre-landing position above the net and is now hovering above it at a height “L”. The height and the roll angle of the deck relative to the aircraft can be determined by any method known in the art, e.g., by using three proximity sensors, such that the landing system that controls the actual landing has such data at any given time. The aircraft will hover above the landing surface and a decision will be made on the mode of descent, based on the relative state of the surface and the horizon.

The actual landing of the aircraft from its position in FIG. 1B can be directed by an automatic system, or can be commanded by a human operator. In both cases pertinent data must be provided to the landing system and/or operator, relative to weather conditions, wind speed and direction, deck movements, wave motion, etc., to allow reaching a decision regarding the speed of the descent of the aircraft into the net. Thanks to the fact that the aircraft has vertical landing capabilities it may approach the net slowly, and this will be desirable when the sensors gauging environmental conditions (which may be located on the aircraft, the ship or both) will indicate relatively low dynamics of the system, e.g., by analyzing the relative state of the aircraft and of the landing surface and the rate of change thereof, which will determine the speed of descent. However, in severe weather conditions or extreme dynamics of the system the landing system and/or operator will cut the engines of the aircraft at a greater distance from the net and allow it to drop quickly into the net.

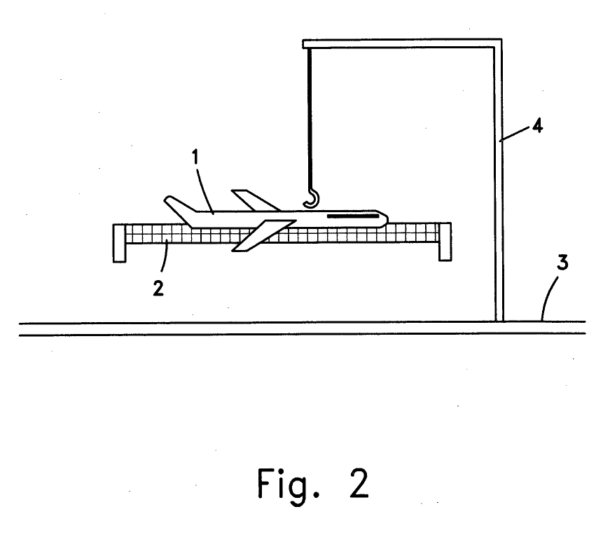

FIG. 2 shows the aircraft already captured in the net. It can be lifted from it using simple lifting apparatus, as schematically illustrated at numeral 4. After refueling and any other maintenance, the aircraft is ready to take off again without the need for mechanical repairs.

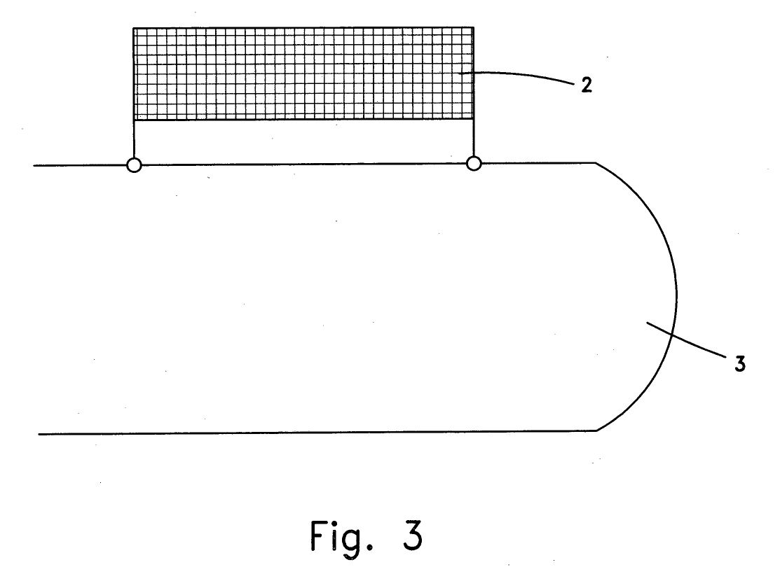

As will be apparent to the skilled person the net does not necessarily have to be positioned on the deck itself, but rather may be located outside the perimeter of the ship and connected to it, as a schematically illustrated in FIG. 3.

Of course, the landing control system must gain control of the aircraft when it is unmanned and must be capable of controlling the speed at which it approaches the net, including the ability of cutting off the aircraft engines when a dropped landing is desired. For a manned aircraft the landing system may either give the pilot instructions for landing, or take over remote command over the landing procedure.

The above examples and description have been provided for the purpose of illustration and are not meant to limit the invention in any way. Many variations and alternative arrangements can be provided; for instance, values types of nets can be used, located in different positions and heights on the landing platform; different landing platforms can be used and the relative positions of the aircraft and landing platform, as well as the dynamics of the system, can be determined using a variety of sensors, methods and procedures, all without exceeding the scope of the invention.

1. A system for landing a VTOL aircraft on a landing platform, comprising:
a) a net, positioned in a plane substantially parallel to the plane of the landing platform;
b) proximity sensors suitable to provide data indicative of the distance and orientation of the aircraft from said net;
c) sensors suitable to gauge environmental conditions relevant to the landing of the aircraft; and
d) control apparatus to control the speed at which the aircraft approaches said net.

2. A system according to claim 1, wherein the net is positioned above a solid surface.

3. A system according to claim 1, wherein the net is positioned above or beside a moving surface.

4. A system according to claim 3, wherein the landing platform is a ship and the net is positioned outside its deck.

5. A system according to claim 1, wherein the proximity sensors are located on the aircraft.

6. A system according to claim 1, wherein the proximity sensors are located on the landing platform.

7. A system according to claim 1, wherein the sensors suitable to gauge environmental conditions include one or more of roll angle sensors, wind speed sensors, ship speed sensors, relative positioning of the landing surface and the aircraft and the rate of change of the relative height of the aircraft and the landing surface.

8. A method for landing a VTOL aircraft on a landing platform, comprising the steps of:
a) positioning a net in a plane substantially parallel to the plane of the landing platform;
b) reading proximity data provided by proximity sensors gauging the distance and orientation of the aircraft from said net;
c) gauging environmental conditions relevant to the landing of the aircraft; and
d) controlling the speed at which the aircraft approaches said net according to said proximity data and environmental conditions, until its fuselage rests in said net.

9. A method according to claim 7, wherein controlling is carried out by a human operator.

10. A method according to claim 7, wherein controlling is carried out by an automated system.

11. A method according to claim 10, wherein the automated system comprises one or more of GPS, optical locking means, proximity sensors and circuitry for transforming sensed data into input readable by the flight control system.

12. A method according to claim 7, wherein the engines of the aircraft are cut off before the aircraft touches the net.
